(19) United States
(12) Patent Application Publication
(10) Pub. No.: US 2010/0184896 A1
(43) Pub. Date: Jul. 22, 2010

(54) COMPLEX ESTERS AS SOLVENT FOR PRINTING INKS (I)

(75) Inventors: Peter Bene, Koln (DE); Juergen Baro, Esslingen (DE); Heinz-Gunther Schulte, Kaarst (DE)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/598,705

(22) PCT Filed: Apr. 24, 2008
(86) PCT No.: PCT/EP08/03295

§ 371 Date: Mar. 30, 2010

(30) Foreign Application Priority Data
May 3, 2007 (DE) 10 2007 021 134.3

(51) Int. Cl. C09D 11/00; C08L 91/00; C08K 5/101

(52) U.S. Cl. 524/315; 106/244; 106/31.13

(57) ABSTRACT

Fatty acid esters of C₆₋₂₆ fatty acids and polyvalent alcohols selected from 1,2-propylene glycol, dipropylene glycol, tripropylene glycol, triethylene glycol, glycerine, ditrimethylolpropane, neopentyl glycol, 2-methylpropane-1,3-diol, 1,4-butanediol, 1,6-hexanediol, 1,4-cyclohexanediol, 2-methylpentane-2,4-diol, 2-ethylhexane-1,3-diol, 2,2,4-trimethyl-1,3-pentanediol, 1,3-cyclohexanedimethanol, 1,4-cyclohexanedimethanol and hydroxypivalylhydroxypivalate are suitable as solvents for offset printing inks.

### FIELD OF THE INVENTION

The invention relates to the use of specific complex esters as solvent for printing inks.

### PRIOR ART

There exist at present offset printing inks which have little odor and little taste and which are based on esters of fatty acids and monohydric alcohols. However, owing to their relatively low molecular weight, these esters have a more or less pronounced tendency to migration, which it is wished as far as possible to avoid or at least greatly minimize in the packaging sector. The packaging sector comprises, as packaging materials, not only cardboard boxes but also plastic films of various chemical compositions. A specific phenomenon in the case of such films is swelling, which is important in particular in the case of thin films. This comprises irreversible crease and wave formation in the material. EP 886 671 B1 describes esters of C₆₋₂₂-fatty acids and specific polyhydric alcohols (trimethylolpropane, pentaerythritol, dipentaerythritol, sorbitol and 2-butyl-2-ethyl-1,3-propanediol) as solvents for offset printing inks.

### DESCRIPTION OF THE INVENTION

There is a continuous need for novel solvents for offset printing inks. As is known to the person skilled in the art, such solvents perform the function of dissolving the resins present in the offset printing inks.

It was the object of the present invention to provide solvents for offset printing inks.

These solvents should be distinguished by as low an inherent viscosity as possible. They should furthermore have an excellent dissolving power for solid resins which are suitable for offset printing, in particular for commercially available offset printing ink solid resins.

The offset printing inks which can be prepared on the basis of the solvents should furthermore exhibit good absorption behavior. In the area of printing inks, the absorption behavior is a parameter which is known to the person skilled in the art and customary in the industry. For more detailed information in this context, reference may be made to the example section.

Furthermore, these solvents should in particular be suitable for the area of food packagings and in this respect should be distinguished in particular by a low migration and odor potential. They should moreover exhibit little swelling.

The abovementioned objects are achieved in an excellent manner by using, as a solvent for offset printing inks, fatty acid esters based on C₆₋₂₆-fatty acids and polyhydric alcohols from the group consisting of 1,2-propylene glycol, dipropylene glycol, tripropylene glycol, triethylene glycol, glycerol, ditrimethylolpropane, neopentyl glycol, 2-methyl-propane-1,3-diol, 1,4-butanediol, 1,6-hexanediol, 1,4-cyclohexanediol, 2-methylpentane-2,4-diol, 2-ethyl-hexane-1,3-diol, 2,2,4-trimethyl-1,3-pentanediol, 1,3-cyclohexanedimethanol, 1,4-cyclohexanedimethanol and hydroxypivalyl hydroxypivalate.

The present invention first relates to the use of fatty acid esters based on C₆₋₂₆-fatty acids and polyhydric alcohols from the group consisting of 1,2-propylene glycol, dipropylene glycol, tripropylene glycol, triethylene glycol, glycerol, ditrimethylolpropane, neopentyl glycol, 2-methylpropane-1,3-diol, 1,4-butane-diol, 1,6-hexanediol, 1,4-cyclohexanediol, 2-methyl-pentane-2,4-diol, 2-ethylhexane-1,3-diol, 2,2,4-trimethyl-1,3-pentanediol, 1,3-cyclohexanedimethanol, 1,4-cyclohexanedimethanol and hydroxypivalyl hydroxy-pivalate, as solvents for offset printing inks.

The fatty acid esters to be used according to the invention may be partial esters or full esters. In a preferred embodiment, they are full esters, i.e. all OH groups of the polyhydric alcohols on which the esters are based are completely esterified.

The fatty acid esters can be used individually or as a mixture with one another.

In one embodiment, the fatty acid esters to be used according to the invention have viscosities in the range from 20 mPa·s to 500 mPa·s (measured according to DIN 53299; viscosity measurement using a rotational viscometer at 23° C.) and preferably in the range from 20 to 300 mPa·s.

In one embodiment, the fatty acid esters to be used according to the invention have acid numbers below 10 mg KOH/g and in particular below 5 mg KOH/g.

In one embodiment, the fatty acid esters to be used according to the invention have iodine numbers of from 0 to 150 (measured according to DIN 53241).

In a preferred embodiment, fatty acid esters used are those whose varnish viscosity is in the range from 200 to 3000 mPa·s, preferably from 300 to 1500 mPa·s and in particular from 300 to 1000 mPa·s. Varnish viscosity is to be understood as meaning the viscosity which a solution consisting of 20 parts by weight of the solid resin (customary in the industry) Setalin P 7000 (cf. the example section) and 80 parts by weight of the fatty acid ester serving as a solvent has at 23° C. (measurement of the viscosity by means of a Bohlin rotational viscometer at a shear rate of 50 s⁻¹).

In a further preferred embodiment, fatty acid esters used are those whose Kauri-butanol value is in the range from 25 to 70 and preferably in the range from 30 to 50. The determination of the Kauri-butanol value is to be carried out according to ASTM D 1133, the respective solvent being titrated against a saturated solution of a Kauri resin (“Kauri resin” from Lamee, Göttingen) in n-butanol. The Kauri-butanol value should be determined at 23° C.

In a further preferred embodiment, fatty acid esters used are those whose molecular weight is in the region of at least 500 and in particular from 550 to 1000. A value in the range from 550 to 700 is very particularly preferred.

Examples of suitable fatty acids which are fatty acid building blocks on which the fatty acid esters according to the invention are based are the saturated fatty acids hexanoic acid (caproic acid), heptanoic acid, octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid, octadecanoic acid (stearic acid), nonadecanoic acid, eicosanoic acid (arachidic acid), docosanoic acid (behenic acid) and the unsaturated fatty acids 10-undecenoic acid, lauroleic acid, myristoleic acid, palmitoleic acid, petroselinic acid, oleic acid, elaidic acid, linoleic acid, linolenic acid, elaeostearic acid, gadoleic acid, arachidonic acid, erucic acid, brassidic acid. Preferably, fatty acids of natural origin are used.

In one embodiment, the fatty acids which are the fatty acid building blocks on which the fatty acid esters according to the invention are based have 8 to 18 C atoms.

In one embodiment the polyhydric alcohols, on which the fatty acid esters according to the invention are based as alcohol building blocks, are selected from the group consisting of 1,2-propylene glycol, dipropylene glycol, tripropylene glycol, triethylene glycol, glycerol, ditrimethylolpropane, neopentyl glycol, 2-methyl-propane-1,3-diol, 1,4-butanediol, 1,6-hexanediol, 1,4-cyclohexanediol, 2-methylpentane-2,4-diol, 2-ethyl-hexane-1,3-diol, 2,2,4-trimethyl-1,3-pentanediol and 1,3-cyclohexanedimethanol, 1,4-cyclohexanedimethanol.

In one embodiment, the polyhydric alcohols which form the parent alcohol building blocks of the fatty acid esters according to the invention are selected from the group consisting of neopentyl glycol, ditrimethylol-propane and 1,6-hexanediol and preferably from the group consisting of neopentyl glycol and ditrimethylol-propane.

In one embodiment, the polyhydric alcohols which form the parent alcohol building blocks of the fatty acid esters according to the invention are selected from the group consisting of 1,4-butanediol, dipropylene glycol, tripropylene glycol, triethylene glycol, 1,4-cyclo-hexanediol, 2,2,4-trimethyl-1,3-pentanediol, hydroxy-pivalyl hydroxypivalate (3-hydroxy-2,2-dimethylpropyl 3-hydroxy-2,2-dimethylpropanoate) and 1,4-cyclohexane-dimethanol.

In one embodiment, glycerol is used as the polyhydric alcohol which forms the parent alcohol building blocks of the fatty acid esters according to the invention.

The invention furthermore relates to offset printing inks which contain one or more resins and one or more solvents, these solvents for the resin(s) being fatty acid esters based on C₆₋₂₆-fatty acids and polyhydric alcohols from the group consisting of 1,2-propylene glycol, dipropylene glycol, tripropylene glycol, triethylene glycol, glycerol, ditrimethylolpropane, neopentyl glycol, 2-methylpropane-1,3-diol, 1,4-butane-diol, 1,6-hexanediol, 1,4-cyclohexanediol, 2-methyl-pentane-2,4-diol, 2-ethylhexane-1,3-diol, 2,2,4-trimethyl-1,3-pentanediol, 1,3-cyclohexanedimethanol, 1,4-cyclohexanedimethanol and hydroxypivalyl hydroxy-pivalate.

In a preferred embodiment, the resins used are those resins which are commercially available in the area of offset printing inks.

In a specific embodiment, the offset printing inks contain a rosin-modified phenol resin (A) and/or a maleate resin (B) and/or a modified hydrocarbon resin (C) and/or a rosin ester (D) and, as solvents for the resin(s), one or more fatty acid esters based on C₆₋₂₆-fatty acids and polyhydric alcohols from the group consisting of 1,2-propylene glycol, dipropylene glycol, tripropylene glycol, triethylene glycol, glycerol, ditrimethylolpropane, neopentyl glycol, 2-methyl-propane-1,3-diol, 1,4-butanediol, 1,6-hexanediol, 1,4-cyclohexanediol, 2-methylpentane-2,4-diol, 2-ethyl-hexane-1,3-diol, 2,2,4-trimethyl-1,3-pentanediol, 1,3-cyclohexanedimethanol, 1,4-cyclohexanedimethanol and hydroxypivalyl hydroxypivalate.

In a preferred embodiment, the offset printing inks according to the invention are completely free of mineral oil.

The offset printing inks according to the invention may contain, over and above the obligatory constituents resin(s), solvent and chromophore, also further constituents, in particular those which are very familiar to the person skilled in the art in this area. It should expressly be noted that chromophores, in particular pigments, are of course an obligatory constituent of offset printing inks.

The offset printing inks according to the invention are preferably free of substances having a migration potential. The resins and fatty acid esters to be used according to the invention, which are present in the binders of the inks, are tailored to one another so that, even in the case of primary packagings, the transfer of material to food is reduced in such a way that the amounts are substantially below the statutory limits. Moreover, virtually no dimensional change takes place, i.e. no migration into the plastic matrix (=no film swelling), in the case of direct contact between the printed ink and, for example a polypropylene packaging film due to virtually complete absence of transfer of material.

The offset printing inks according to the invention may be designated as having little odor, little migration and little swelling and are therefore suitable in particular for the production of food packagings with the use of, for example, cardboard and paper.

### Examples

### Substances Used

Setalin P 7000 Rosin (from Akzo Nobel Resins)
EW-Print 1169 Mineral oil-free coconut alkyd resin (from Cognis Deutschland GmbH)
Texaprint SHM 1 EXP Glyceryl ester of various fatty acids (from Cognis Deutschland GmbH)
Irgalite Blue GLVO Pigment (from Ciba Specialty Chemicals)

### Preparation of the Formulations

### General

Of key importance for the preparation of offset printing ink formulations are the solvents. The dissolving power of the solvents is an essential parameter. This dissolving power was determined by determining the Kauri-butanol value known to the person skilled in the art. This test method is described in more detail under “Test methods used”.

A further parameter for defining the dissolving power of fatty acid esters is the solution viscosity of varnishes (solutions of solid resins in the solvents). The test method used here is described in detail under “Test methods used”.

Finally, it is important that the offset printing ink has good values with respect to the absorption test known to the person skilled in the art and customary in the industry. For this purpose, the offset printing inks were characterized by determining the so-called absorption behavior. This test method is described in detail under “Test methods used”.

### The Formulations

The preparation of offset printing ink formulations was effected in two steps.

First (step 1), 20 parts by weight of the solid resin Setalin P 7000 were mixed with 80 parts by weight of the solvent to be investigated in each case and heated to 180-200° C. with stirring. A solution of the solid resin in the respective solvent was obtained. This solution is designated—as customary in the technical area—as a varnish.

The varnishes were characterized by determining their viscosity. The test method used here is described in detail under “Test methods used”.

Finally, (step 2), the offset ink formulations were prepared as follows: one part of the varnish was mixed with the alkyd resin EW-Print 1169 (free of mineral oil). The pigment Irgalite Blue GLVO was then stirred in. The mixture was dispersed by means of a three-roll mill. The remaining varnish was added to the ink concentrate thus obtained, and the solvent on which the varnish is based was added again for establishing the desired final viscosity of the offset printing ink.

The tables of examples E1 to E3 and of comparative example C1 show in each case:
the composition of the varnishes (% by weight of the individual constituents, based on the total varnish)
the final composition of the offset printing inks (% by weight of the individual constituents, based on the total offset printing ink).

### Test Methods Used

### 1) Dissolving Power

The so-called Kauri-butanol value is frequently used by experts to determine the dissolving power of printing ink resins. The Kauri-butanol value characterizes the dissolving power of the solvents.

Accordingly, the determination of the dissolving power was effected by measuring the Kauri-butanol value according to ASTM D 1133. For determining the Kauri-butanol value, the respective solvent was titrated against a saturated solution of a Kauri resin (“Kauri resin” from Lamee, Göttingen) in n-butanol. The Kauri-butanol value was determined at 23° C.

Typical Kauri-Butanol Values are:

Aromatics-free mineral oils about 20
Aromatics-rich mineral oils about 40-50
Toluene about 105-110

### 2) Solution Viscosity

The viscosity determination was effected according to the Eurocommit method known to the person skilled in the art. For this purpose, 20 parts by weight of the resin Setalin P 7000 were mixed with 80 parts by weight of the respective solvent component, and the resin was dissolved by heating to 180-200° C. with stirring. The solution (such solutions are designated as a varnish by the person skilled in the art) was then cooled to 23° C. Thereafter, the viscosities of the individual varnishes were determined with the aid of a Bohlin rotational viscometer. The values were measured at a shear rate of 50 s⁻¹ at 23° C.

### 3) Tack Freeness of Printed Surfaces: Absorption Test

For further characterization of the offset printing inks, the so-called absorption test was carried out.

Regarding the principle of the test, the following may be stated: the purpose is to check the time taken for an ink film, after the end of printing, to become nontacky in the stack or in the roll, a process which can in principle take place within seconds to minutes but which can also take a few hours, depending on ink and substrate. On absorption, the solvents separate from the solid or pasty ink constituents, which remain behind as a solid ink film on the substrate surface. Consequently, when carrying out the test under discussion here, the solvents present in the offset printing ink enter the interior of the substrate (=the material to be printed), they are “absorbed”. The faster an ink film becomes nontacky, i.e. the faster the solvents are absorbed into the substrate, the faster is it also possible to effect printing, since there is then no danger of fresh ink being transferred from the printed front to the unprinted back by smearing or deposition in the paper stack or in the paper roll under pressure.

For carrying out the absorption test specifically, 1.5 g/m² of the offset printing ink prepared in each case was printed on coated cardboard (GD-2 (280 g/cm³)) with the aid of an offset proof printer from Prüfbau. Directly thereafter, a further paper (APCO II/II (150 g/cm³)) was pressed against the printed cardboard. The pressure was eliminated in each case after 30 s, 60 s, 120 s and 240 s.

Depending on the pressing time, a more or less strong coloration of the cardboard was found on the substrate in reverse printing, which coloration is dependent on absorption of the solvent.

The intensity of the coloration (ink density) on the cardboard was measured using a colorimeter and is an indication of the absorption behavior of a solvent into the cardboard. The higher the color intensity (values in practice are from 0 to 2.5), the slower the absorption of the solvent has taken place. The values determined in the absorption test are dimensionless numbers. The lower the value, the more solvent was absorbed into the interior of the substrate and therefore the better is the tack freeness of the printed surface.

### EXAMPLE FORMULATIONS

### Example 1

### Comparative Example (C1)

The preparation of varnish and offset printing ink was effected as described above. The composition of varnish and offset printing inks is shown in the following table. The data—here as also in the following examples—appear in each case in parts by weight, based on the total varnish or the total offset printing ink:

| Varnish | | Offset printing ink | |
|---|---|---|---|
| Setalin P 7000 | 20 | Setalin P 7000 | 14.8 |
| Pentaerythrityl | 80 | EW-Print 1169 | 8 |
| tetraoctanoate | | | |
| | | Pentaerythrityl | 59.2 |
| | | tetraoctanoate | |
| | | Irgalite Blue GLVO | 18 |

Measured data (according to the test methods described above):
viscosity of pentaerythrityl tetraoctanoate: 41 mPa·s
molecular weight of pentaerythrityl tetra-octanoate: 641
viscosity of the varnish: 1280 mPa·s
dissolving power of pentaerythrityl tetraoctanoate (Kauri-butanol value): 40
absorption test of the offset printing ink: 0.85 (at 30 s), 0.70 (at 60 s), 0.28 (at 120 s), 0.06 (at 240 s)

### Example 2

### Example According to the Invention (E1)

The preparation of varnish and offset printing ink was effected as described above. The composition of varnish and offset printing inks appears in the following table:

| Varnish | | Offset printing ink | |
|---|---|---|---|
| Setalin P 7000 | 20 | Setalin P 7000 | 14.8 |
| Neopentyl glycol | 80 | EW-Print 1169 | 8 |
| dioleate | | | |
| | | Neopentyl glycol | 59.2 |
| | | dioleate | |
| | | Irgalite Blue GLVO | 18 |

Measured data (according to the test methods described above):
viscosity of neopentyl glycol dioleate: 35 mPa·s
molecular weight of neopentyl glycol dioleate: 621
viscosity of the varnish: 640 mPa·s
dissolving power of neopentyl glycol dioleate (Kauri-butanol value): 31
absorption test of the offset printing ink: 0.71 (at 30 s), 0.25 (at 60 s), 0.05 (at 120 s), 0.01 (at 240 s)

### Example 3

### Example According to the Invention (E2)

The preparation of varnish and offset printing ink was effected as described above. The composition of varnish and offset printing inks appears in the following table:

| Varnish | | Offset printing ink | |
|---|---|---|---|
| Setalin P 7000 | 20 | Setalin P 7000 | 14.8 |
| Neopentyl glycol | 80 | EW-Print 1169 | 8 |
| dicocoate | | | |
| | | Neopentyl glycol | 59.2 |
| | | dicocoate | |
| | | Irgalite Blue GLVO | 18 |

Measured data (according to the test methods described above):
viscosity of neopentyl glycol dicocoate: 25 mPa·s
molecular weight of neopentyl glycol dicocoate: 580
viscosity of the varnish: 360 mPa·s
dissolving power of neopentyl glycol dicocoate (Kauri-butanol value): 38
absorption test of the offset printing ink: 0.55 (at 30 s), 0.21 (at 60 s), 0.03 (at 120 s), 0.00 (at 240 s)

### Example 4

### Example According to the Invention (E3)

The preparation of varnish and offset printing ink was effected as described above. The composition of varnish and offset printing inks appears in the following table:

| Varnish | | Offset printing ink | |
|---|---|---|---|
| Setalin P 7000 | 20 | Setalin P 7000 | 14.8 |
| Texaprint SHM 1 EXP | 80 | EW-Print 1169 | 8 |
| | | Texaprint SHM 1 EXP | 59.2 |
| | | Irgalite Blue GLVO | 18 |

Measured data (according to the test methods described above):
viscosity of Texaprint SHM 1 EXP: 34 mPa·s
molecular weight of Texaprint SHM 1 EXP: 580
viscosity of the varnish: 500 mPa·s
dissolving power of Texaprint SHM 1 EXP (Kauri-butanol value): 47
absorption test of the offset printing ink: 0.85 (at 30 s), 0.65 (at 60 s), 0.22 (at 120 s), 0.04 (at 240 s)

### Overview of the Measured Data

The measured data already mentioned above are listed again below in table form for the sake of clarity:

### Solution Viscosities of the Varnishes

| cf. | | |
|---|---|---|
| Example | Varnish based on the solvent | Viscosity |
| C1 | Pentaerythrityl tetraoctanoate | 1280 mPa · s |
| E1 | Neopentyl glycol dioleate | 640 mPa · s |
| E2 | Neopentyl glycol dicocoate | 360 mPa · s |
| E3 | Glyceryl esters of various fatty acids | 500 mPa · s |

### Dissolving Power of the Solvents

| Solvent | Kauri-butanol value |
|---|---|
| Pentaerythrityl tetraoctanoate | 40 |
| Neopentyl glycol dioleate | 31 |
| Neopentyl glycol dicocoate | 38 |
| Glyceryl esters of various fatty acids | 47 |

### Absorption Behavior of the Offset Printing Inks (Absorption Test)

| Offset | | Result of the | | | |
|---|---|---|---|---|---|
| printing ink | Solvent present | absorption | | | |
| according to | in the offset | test | | | |
| example | printing ink | 30 s | 60 s | 120 s | 240 s |
| C1 | Pentaerythrityl | 0.85 | 0.70 | 0.28 | 0.06 |
| | tetraoctanoate | | | | |
| E1 | Neopentyl | 0.71 | 0.25 | 0.05 | 0.01 |
| | glycol dioleate | | | | |
| E2 | Neopentyl | 0.55 | 0.21 | 0.03 | 0.00 |
| | glycol | | | | |
| | dicocoate | | | | |
| E3 | Glyceryl esters | 0.85 | 0.65 | 0.22 | 0.04 |
| | of various | | | | |
| | fatty acids | | | | |

1. An offset printing ink solvent composition comprising fatty acid esters based on C₆₋₂₆-fatty acids and polyhydric alcohols selected from the group consisting of 1,2-propylene glycol, dipropylene glycol, tripropylene glycol, triethylene glycol, glycerol, ditrimethylolpropane, neopentyl glycol, 2-methylpropane-1,3-diol, 1,4-butanediol, 1,6-hexanediol, 1,4-cyclohexanediol, 2-methylpentane-2,4-diol, 2-ethylhexane-1,3-diol, 2,2,4-trimethyl-1,3-pentanediol, 1,3-cyclohexanedimethanol, 1,4-cyclohexanedimethanol, and hydroxypivalyl hydroxypivalate, and mixtures thereof.

2. The composition according to claim 1, wherein the fatty acid esters are full esters.

3. The composition according to claim 1, wherein the fatty acids are natural fatty acids having 8 to 18 C atoms.

4. An offset printing ink composition comprising one or more resins and one or more solvents, wherein the solvents for the resin(s) are fatty acid esters based on C₆₋₂₆-fatty acids and polyhydric alcohols selected from the group consisting of 1,2-propylene glycol, dipropylene glycol, tripropylene glycol, triethylene glycol, glycerol, ditrimethylolpropane, neopentyl glycol, 2-methylpropane-1,3-diol, 1,4-butanediol, 1,6-hexanediol, 1,4-cyclohexanediol, 2-methylpentane-2,4-diol, 2-ethylhexane-1,3-diol, 2,2,4-trimethyl-1,3-pentanediol, 1,3-cyclohexanedimethanol, 1,4-cyclohexanedimethanol, hydroxypivalyl hydroxypivalate, and mixtures thereof.

5. The offset printing ink composition according to claim 3, wherein the resins comprise at least one component selected from the group consisting of a rosin-modified phenol resin, a maleate resin, a modified hydrocarbon resin, and a rosin ester.

6. The offset printing ink composition according to claim 4, wherein the fatty acid esters are full esters.

7. The composition according to claim 2, wherein the fatty acid esters are full esters.

8. The offset printing ink composition according to claim 5, wherein the fatty acid esters are full esters.
